(19) United States
(12) Patent Application Publication
(10) Pub. No.: US 2014/0245267 A1
(43) Pub. Date: Aug. 28, 2014

(54) TEST CASE SCREENING METHOD AND SYSTEM

(71) Applicant: Tencent Technology (Shenzhen) Company Limited, Shenzhen Guangdong (CN)

(72) Inventors: Juhong Wang, Shenzhen Guangdong (CN); Lin Yuan, Shenzhen Guangdong (CN); Shuohao Ke, Shenzhen Guangdong (CN); Xin Huang, Shenzhen Guangdong (CN); Jinze Chen, Shenzhen Guangdong (CN); Yichun Han, Shenzhen Guangdong (CN)

(73) Assignee: Tencent Technology (Shenzhen) Company Limited, Shenzhen Guangdong (CN)

(21) Appl. No.: 14/272,065

(22) Filed: May 7, 2014

Related U.S. Application Data
(63) Continuation of application No. PCT/CN2013/072536, filed on Mar. 13, 2013.

(30) Foreign Application Priority Data
Mar. 28, 2012 (CN) 201210086547.9

(51) Int. Cl. G06F 11/36

(52) U.S. Cl. CPC G06F 11/3672
USPC 717/124

(57) ABSTRACT

A method of screening test cases used to test a software system is provided. The method may include obtaining a number of times that a function node of the software system is triggered. A weight of the function node may be calculated based on the number of times that the function node is triggered. Further, test cases relevant to the function node may be screened according to the weight of the function node. Thus, a test case relevant to the function node that is triggered more frequently during an operation may be screened for. The number of times a function node is triggered may indicate a frequency with which the function node is used, and the function node that is frequently used may be of great importance. A system and a computer medium with instructions to provide improve testing of the software system are also provided.

This application is a continuation application of PCT international application PCT/CN2013/072536, filed on Mar. 13, 2013, which claims the priority of Chinese Patent Application No. 201210086547.9, entitled “TEST CASE SCREENING METHOD AND SYSTEM”, filed with the Chinese Patent Office on Mar. 28, 2012, both of which are incorporated herein by reference in their entirety.

### FIELD

The present disclosure relates to software testing and in particular to a test case screening method and system.

### BACKGROUND

Testing may be an important phase in a development lifecycle of a software application or a software system. A software system, typically, may be tested repeatedly before the software system is accepted and put into use. A test on the software system may performed by executing test cases. Each test case, generally, may include a test object, a test environment, input data, test steps and an expected result. During the test process, the test environment may be built as per the test case. The input data may be input during the test steps, and an output result may be compared with the expected result. Test cases covering all functional nodes of the software system may be developed to analyze the software system in its entirety.

The software system may be modified or updated a number of times. The developed tests may be performed on every modified version of the software system each time the software system may be modified. All the test cases may be executed after each modification or update. In the foregoing solution, the test cases may not have been screened and possibly all test cases may be executed or processed. Consequently, test cases which may not have high pertinence may be executed. Thus, there may be a repeated and redundant effort in the test process, which may degrade or reduce test efficiency.

### SUMMARY

In one aspect, a test case screening method is provided to improve efficiency of the tests.

The test case screening method may include obtaining a number of times each functional node from among multiple functional nodes has been triggered. The functional nodes may be those of a software system to be tested. The method may further include calculating a weight of each functional node based on the number of times the functional node has been triggered. Further, the method may involve screening test cases pertinent to each functional node according to the weight of each functional node.

In another aspect, a test case screening system capable of improving efficiency of testing a software system is provided.

A test case screening system may include a trigger-times obtaining module configured to obtain a number of times a functional node of the software system has been triggered. The software system may include several functional nodes. The system may also include a weight calculating module configured to calculate a weight of the functional node according to the number of times the functional node has been triggered. The system may further include a test case screening module configured to screen test cases pertinent to the functional node according to the weight of the functional node.

Further, in yet another aspect, a computer storage medium including computer executable instructions may be provided. The computer executable instructions may be executable by one or more processors to perform a test case screening method capable of improving the efficiency of testing a software application.

The computer executable instructions may include instructions to obtain a numbers of times a functional node has been triggered. The functional node may be one of several functional nodes of the software application. Further, there may be instructions to calculate a weight of the functional node according to the number of times the functional node has been triggered. Further, instructions may be provided to screen test cases pertinent to the functional node according to the weights of the functional node.

In the foregoing aspects of a test case screening method and system, after a software system has been in operation for a period of time, a number of times that a functional node has been triggered is retrieved. The functional node may be one of several functional nodes in a software system or software application. The software system may be the software system to be tested. The number of times the functional node is triggered indicates a frequency with which the functional node is accessed during operation of the software system. Further, as described in the embodiments, a weight of each functional node of the software system may be calculated based on the number of times that each functional node is triggered. Further, test cases pertinent to the functional nodes of the software system may be screened or selected based on the calculated weights of the functional nodes. The foregoing solution may screen out the test cases pertinent to the functional nodes which have been triggered for a large number of times i.e. more frequently, during operation of the software system. A larger number of times that a functional node has been triggered i.e. a higher frequency of use of the functional node, may indicate a greater importance of the functional node. Thus, a solution is provided to select the test cases pertinent to the functional nodes with greater importance during operation of the software system. Thus, a solution is provided to screen or select the test cases that are of high pertinence for testing the software system. Thus, a test including the screened test cases may be performed to improve the efficiency of testing the software system.

### BRIEF DESCRIPTION OF THE DRAWINGS

FIG. 1 is a schematic flow chart of example steps performed by an example of the test case screening method; and

FIG. 2 is a schematic structural diagram of an example of the test case screening system.

### DETAILED DESCRIPTION OF EMBODIMENTS

It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. Alternatively, or in addition, one or more functional blocks or units may also be implemented in a common circuit, chip, circuit element or unit.

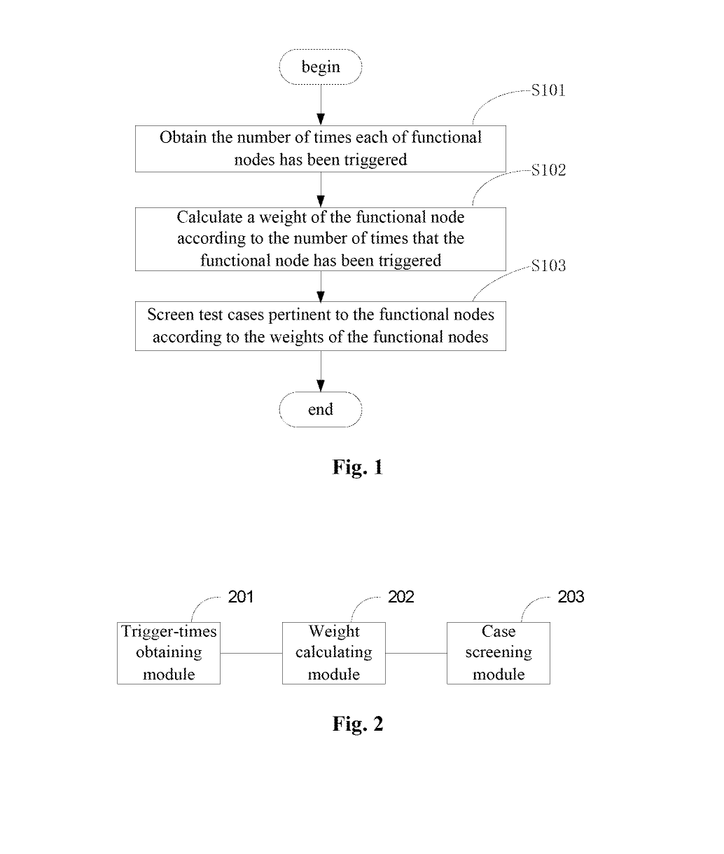

As illustrated in FIG. 1, in an embodiment, a test case screening method may include the following steps S101-S103.

In step S101 a count of the number of times each functional node of a software system to be tested has been triggered may be monitored and identified.

In an embodiment, a statistic code may be added in advance to program instructions or code related to each functional node. The statistic code embedded in the code related to the functional node may be executed when the functional node is triggered. The statistic code may write a log of the functional node being triggered. The log may be recorded, for example, into a specified file or database. The number of times that the functional node has been triggered may be retrieved from the log that may be recorded in the specified file or database. The log may be retrieved when the software system has been in a stable operation for a preset period.

Step S102 may involve calculating a weight of each functional node using the number of times that a functional node has been triggered.

In an embodiment, the weight of the functional node may be calculated as a ratio of the number of times that the functional node has been triggered to the total number of times that all functional nodes have been triggered.

The weight of the functional node, in such a case, may be calculated using the formula of: the weight of the functional node=the number of times that the functional node has been triggered/the total number of times that all functional nodes have been triggered. That is, the weight of a functional node X in the system may be the ratio of the number of times that the functional node X has been triggered to the total number of times that all functional nodes in the system have been triggered. Other embodiments may use different formulas for calculation of the weight of the functional node.

The more the number of times that the functional node has been triggered, the higher the weight of the functional node calculated in the foregoing formula. Other relations between the number of times the functional node has been triggered and the weight of the functional node may be established. For example, the weight may be inversely related to the number of times accessed.

Step S103 may involve screening test cases pertinent to the functional nodes according to the weights of the functional nodes.

In an embodiment, a preset number of functional nodes ranked higher according to the associated weights may be retrieved, and the test cases pertinent to the retrieved functional nodes may be selected.

For example, the functional nodes may be ranked in an order of descending weights and the first preset number of the ordered functional nodes may be selected. Further, the test cases pertinent to the selected first preset number of functional nodes may be selected in a case library.

The functional nodes ranked higher by the weights may be deemed important functional nodes. In such a case, the test cases pertinent to the important functional nodes, i.e. those functional nodes ranked higher according to the associated weights, may be selected for execution. Such test cases, pertinent to the important functional nodes, may be deemed important test cases. Thus, the available test cases may be screened to select the test cases considered important and pertinent.

In another embodiment, the step S103 may include calculating an average weight of the functional nodes, and retrieving functional nodes with weights above the average weight. Step S103, may further involve selecting the test cases pertinent to the retrieved functional nodes in this manner.

The average weight of the functional nodes may be calculated by dividing a sum of the weights of all the functional nodes by a total number of functional nodes. In one example, the sum of the weights of all the functional nodes may be 1. The functional nodes with associated weights above the average weight may be retrieved, and further, the test cases pertinent to such retrieved functional nodes may be selected in the case library.

Alternatively, or in addition to the above embodiment, the functional nodes with the weights above the average weight may be deemed the important functional nodes. The test cases associated with the important functional nodes determined in this embodiment may be deemed as the tests cases with high importance and/or pertinence. Thus, the test cases of high importance and/or pertinence may be screened for execution.

In a further embodiment, in the step S103, the test cases pertinent to the functional nodes may be selected according to the weights of the functional nodes, so that a proportion, or a ratio, of the test cases pertinent to each of the functional nodes to the total number of selected test cases is equal to the weight of the functional node. For example, the weights of a functional node 1, a functional node 2 and a functional node 3 may be 5/10, 3/10 and 2/10 respectively. Then, the case library may be searched for a part or all of test cases pertinent to the functional node 1. Say, 500 test cases pertinent to the functional node 1 are retrieved from the case library. Since, in this example, ratio of the weights of the functional node 1, the functional node 2 and the functional node 3 is 5:3:2, the ratio of the number of test cases selected for the functional node 1, the functional node 2 and the functional node 3 may also be maintained as 5:3:2. To this end, 300 test cases pertinent to the functional node 2 and 200 test cases pertinent to the functional node 3 may be retrieved from the case library.

In this embodiment, the number of test cases selected for a functional node is determined, or assigned, according to the weight associated with the functional node. Therefore, more test cases may be selected for a functional node with a higher weight, while lesser number of test cases may be selected for a functional node with a lower weight. The number of test cases selected for the functional node may reasonably reflect an importance of the functional nodes. Thus, test cases may be selected to cover a larger range of functional nodes so that more test cases may be selected for a functional node with a greater importance. Further, even if there are several test cases for the functional node available, all of the test cases may not be selected, rather only a number of tests cases according to the weight of the functional node may be selected. Consequently, the test cases are screened, so that the number of test cases assigned for execution to test the functional node may be according to the importance of the functional node. Thus, a test for the software system, performed with the test cases selected according to the above method, may improve the efficiency of the test.

In an embodiment, the foregoing test case screening method may further include a step of retrieving the number of times that a user interface component associated with the functional node has been accessed.

In this embodiment, the step S102 may include calculating the weight of the functional node according to the number of times that the functional node has been triggered and the number of times that the user interface component associated with the functional node has been accessed.

The user interface component may be a page, a button, or any other user interface component for interaction with a user of the software system. Accessing the user interface component may trigger the functional node associated with the user interface component. Such a relationship between the user interface component and the functional node may be a one-to-many relationship or a many-to-many relationship.

In one embodiment, a statistic code may be added to program instructions or code of the user interface component associated with the functional node. When a user accesses the user interface component, the code of the user interface component and also the statistic code embedded in the code may be executed. The statistic code may write a log of the user interface component being accessed into a specified file or database. The number of times that the user interface component has been accessed may be retrieved from the log that may be in the specified file or database. The log may be accessed after the system has been in stable operation for the preset period.

In the step S 102, a first ratio of the number of times that the functional node has been triggered to the total number of times that all functional nodes have been triggered may be calculated. Further, a second ratio of the number of times that the user interface component associated with the functional node has been accessed to the total number of times that all user interface components have been accessed may be calculated. The weight of the functional node may be selected as an average of the first weight and the second weight.

For instance, in the step S102, the weight of the functional node may be calculated using the formula of: the weight of a functional node=(the number of times that the functional node has been triggered/the total number of times that all the functional nodes have been triggered+the number of times that the user interface component associated with the functional node has been accessed/the total number of times that all the user interface components have been accessed)/2. That is, the weight of a functional node in the system may be equal to the average of the first ratio and the second ratio. Here, the first ratio may be the ratio of the number of times that the functional node has been triggered to the total number of times that all the functional nodes in the system have been triggered, and the second ratio may be the ratio of the number of times that the user interface component associated with the functional node has been accessed to the total number of times that all the user interface components in the system have been accessed.

In this embodiment, the step S103 of calculating the average weight of the functional nodes may include calculating a third ratio of a sum of the weights of all the functional nodes to the total number of functional nodes. This may be used for calculating a fourth ratio of the average number of times that all the user interface components have been accessed to the total number of times that all the user interface components have been accessed. Further, the step S103 may involve calculating the average weight of the functional nodes as the average of the third ratio and the fourth ratio.

Thus, the weight of a functional node may be calculated, according to the proportion of the number of times that the functional node has been triggered to the total number of times that all the functional nodes have been triggered and the proportion of the number of times that a user interface component associated with the functional node has been accessed to the total number of times that all the user interface components have been accessed. The more the number of times that the functional node has been triggered, or the more the number of times that the user interface component associated with the functional node has been accessed, the higher may be the weight of the functional node. The number of times that a functional node is triggered or the number of times that a user interface component associated with the functional node has been accessed may indicate an importance of the functional node. Thus, based on the example weight calculation described above, in an embodiment, a higher weight of a functional node may indicate a greater importance of the functional node. Test cases of functional nodes may be selected according to the weights of the functional nodes. Accordingly, the test cases related to the functional nodes with greater importance may be selected as the test cases of higher pertinence. In this way, the test of the software system may be performed with the only test cases with higher pertinence selected for execution, to improve the test efficiency.

In an embodiment, the foregoing method may further include the step of performing the test with the screened test cases, i.e. the selected test cases.

In an automatic test method, input data of each of the test cases may be input to the software system as the test steps are performed. A result output from the software system may be compared with an expected output data for the test case. If the result output and the expected output data match, the test case may be considered passed; otherwise, the test case may be considered failed and an error report may be output in such a case.

As described, the test cases of the functional nodes with greater importance are screened, and the test performed with the screened test cases, improving the efficiency of testing the software system.

As illustrated in Fig.2, in an embodiment, a test case screening system may include a trigger-times obtaining module 201, a weight calculating module 202 and a case screening module 203.

The trigger-times obtaining module 201 may obtain the number of times each of functional nodes has been triggered.

In an embodiment, a statistic code may be embedded in advance in a code related to each functional node. The statistic code may be executed when the functional node is triggered. The statistic code may write a log of the functional node being triggered. The log may be recorded into a specified file or database. The trigger-times obtaining module 201 may retrieve the number of times that the functional node may have been triggered from the log after the software system has been in stable operation for a preset period.

The weight calculating module 202 may calculate a weight of each functional node according to the number of times that the functional node has been triggered.

In an embodiment, the weight calculating module 202 may calculate the weight of the functional node as a ratio of the number of times that the functional node has been triggered to the total number of times that all functional nodes have been triggered.

The weight calculating module 202 may calculate the weight of the functional node using the formula of: the weight of the functional node=the number of times that a functional node has been triggered/the total number of times that all functional nodes have been triggered. That is, the weight of a functional node in the system may be equal to the ratio of the number of times that the functional node has been triggered to the total number of times that all the functional nodes in the system have been triggered.

Thus, in one embodiment, the more the number of times that the functional node has been triggered, the higher the weight of the functional node calculated in the foregoing formula. Other relations between the number of times the functional node has been triggered and the weight of the functional node may be established. For example, the weight may be inversely related to the number of times accessed.

The case screening module 203 may screen test cases pertinent to the functional nodes according to the weights of the functional nodes.

In an embodiment, the case screening module 203 may retrieve a preset, or predetermined number of functional nodes ranked higher according to the corresponding weights. The case screening module 203 may then select the test cases pertinent to the retrieved functional nodes.

The case screening module 203 may rank the functional nodes in an order of descending weights, before selecting the preset number of functional nodes. The first preset number of the ordered tests may be selected. The test cases selected pertinent to the first preset number of functional nodes may be added to a case library.

The functional nodes ranked higher by the weights may be the important functional nodes. Thus, the selection of the test cases pertinent to the functional nodes ranked higher by the weights screens out the test cases with great importance and pertinence.

In another embodiment, the weight calculating module 202 may calculate an average weight of the functional nodes. Further, the case screening module 203 may retrieve functional nodes with the weights above the average weight and further, may select test cases pertinent to the retrieved functional nodes.

Specifically the weight calculating module 202 may calculate the average weight of the functional nodes by dividing a sum of the weights of all the functional nodes by the total number of functional nodes. The case screening module 203 may retrieve the functional nodes with the weights above the average weight and further, may select only the test cases pertinent to the retrieved functional nodes in the case library.

In addition to the functional nodes selected earlier, or alternatively, functional nodes with corresponding weights above the average weight may also be deemed important functional nodes. Thus, additional or alternative test cases of high importance may be screened out in this manner.

In a further embodiment, the test case screening module 203 may select the test cases pertinent to the functional nodes according to the weights of the functional nodes, so that the proportion of the test cases pertinent to each of the functional nodes to all the selected test cases is equal to the weight of the functional node. For example, consider a case where the weights of a functional node 1, a functional node 2 and a functional node 3 are 5/10, 3/10 and 2/10 respectively. The available test cases in the case library may be searched for test cases pertinent to the functional node 1. In an example, 500 test cases pertinent to the functional node 1 are retrieved from the case library. Now, in this example, the ratio of the weights of the functional node 1, the functional node 2 and the functional node 3 is 5:3:2. Hence, in this example, the ratio of the number of test cases selected for the functional node 1, the functional node 2 and the functional node 3 is also 5:3:2. Therefore, in this case, 300 test cases pertinent to the functional node 2 and 200 test cases pertinent to the functional node 3 may be further retrieved from the case library.

In this embodiment, the number of test cases to be selected for a functional node may be assigned according to the weight of the functional node. In this way, more test cases may be selected for the functional node with a higher weight, and lesser number of test cases may be selected for the functional node with a lower weight. The number of test cases selected for the functional node may reasonably reflect an importance of the functional nodes. Thus, as described above, test cases covering a larger number of functional nodes may be selected such that more test cases may be selected pertinent to a functional node with greater importance. Consequently, the foregoing solution may screen out the test cases, and yet a reasonable number of test cases may be assigned to test a functional node according to the importance of the functional node. A software system may be tested by performing a test including the screened test cases. This may improve the efficiency of the test compared to execution of all the available test cases or executing tests which may not be pertinent to functional nodes of greater importance.

In an embodiment, the trigger-times obtaining module 201 may further retrieve the number of times that a user interface component associated with the functional node has been accessed.

In this embodiment, the weight calculating module 202 may calculate the weight of the functional node according to the number of times that the functional node has been triggered and the number of times that the user interface component associated with the functional node has been accessed.

The user interface component may be a page, a button, or any other user interface component applicable, for interaction with a user at a front end of the software system. Accessing the user interface component at the front end may trigger the functional node, which may be at a back end of the software system and associated with the user interface component. The association between the user interface component at the front end and the functional node at the back end may be a one-to-many association or a many-to-many association. Thus, accessing one user interface may trigger one or more functional nodes at the back end.

In an embodiment, a statistic code may be embedded in a code of the user interface component. When the user accesses the user interface component, the code of the user interface component may be executed. The embedded statistic code may be executed in response, and the statistic code may write a log of the user interface component being accessed. The log may be recorded in a specified file or database. The weight calculating module 202 may retrieve the number of times that the user interface component has been accessed from the log in the specified file or database after the system has been in stable operation for the preset period.

The weight calculating module 202 may calculate a first ratio of the number of times that the functional node has been triggered to the total number of times that all the functional nodes have been triggered. The weight calculating module 202 may also calculate a second ratio of the number of times that the user interface component associated with the functional node has been accessed to the total number of times that all user interface components have been accessed. Further, the weight calculating module 202 may calculate the weight of the functional node as the average of the first weight and the second weight.

For example, the weight calculating module 202 may calculate the weight of the functional node using the following formula: the weight of a functional node=(the number of times that the functional node has been triggered/the total number of times that all the functional nodes have been triggered+the number of times that the user interface component associated with the functional node has been accessed/the total number of times that all the user interface components have been accessed)/2. That is, the weight of a functional node in the system may be equal to the average of the first ratio and the second ratio, where the first ratio is the ratio of the number of times that the functional node has been triggered to the total number of times that all the functional nodes in the system have been triggered, and the second ratio is the ratio of the number of times that the user interface component associated with the functional node has been accessed to the total number of times that all the user interface components in the system have been accessed. The weight calculating module 202 may calculate the weight of the functional node using other formulae or calculation.

The weight calculating module 202 may calculate a third ratio of the sum of the weights of all the functional nodes to the total number of all the functional nodes. The weight calculating module 202 may further calculate a fourth ratio of the average number of times that all the user interface components have been accessed to the total number of times that all the user interface components have been accessed. Based on these, the weight calculating module 202 may calculate the average weight of the functional nodes as the average of the third ratio and the fourth ratio.

The weight calculating module 202 may calculate the weight of a functional node, according to the proportion of the number of times that the functional node has been triggered to the total number of times that all the functional nodes have been triggered and the proportion of the number of times that a user interface component associated with the functional node has been accessed to the total number of times that all the user interface components have been accessed. The more the number of times that the functional node has been triggered, or the more the number of times that the user interface component associated with the functional node has been accessed, the higher the weight that may be associated with the functional node. Thus, larger the number of times that a functional node has been triggered greater the importance associated with the functional node. In addition, or alternatively, larger the number of times that a user interface component associated with the functional node has been accessed greater the importance associated with the functional node. Further, based on the example calculation of the weight described above, higher the weight of a functional node greater the importance of the functional node. Subsequently, test cases for the functional nodes with greater importance may be selected based on the weights of the functional nodes. Thus, to select the test cases of higher pertinence, test cases related to the functional nodes with higher weights may be selected. In this way, a test performed with test cases selected according to above description, may have an improved efficiency. This may be because, if the above selection process is not performed, all test cases may have to be performed leading to repeated and redundant tests.

An embodiment of the test case screening system may further include a test case screening module (not shown in FIG. 2). The test case screening module may perform a test with the screened-out test cases.

The test case screening module may input data during execution of each of the test cases of the software system as required by the test steps. The test case screening module may then compare a result output from the software system with the expected output data in the test case. If the result output matches the expected output data, then the test case passes; otherwise, the test case fails and the test case screening module may output an error report.

Thus, the test cases of the functional nodes with greater importance are screened out, and a test is performed with the screened-out test cases, improving the efficiency of testing the software system.

In the foregoing test case screening method and system, after the software system has been in operation for a predetermined period of time, the number of times that each functional node has been triggered may be retrieved. The weight of each functional node may be calculated according to the number of times that the functional node has been triggered. The test cases pertinent to the functional nodes may be screened according to the weights of the functional nodes. This may screen out the test cases pertinent to the functional nodes which have been triggered a larger number of times during operation of the software system. The large number of times that a functional node has been triggered may indicate that the functional node has been used frequently. Further, since the functional node is used frequently, the functional node may be deemed to have a greater importance. Thus, the foregoing description may screen out the test cases pertinent to the functional nodes with greater importance as per the operation of the software system. Thus, the screened-out test cases may be of high pertinence. In this way, a test may be performed with the screened-out test cases to testing the software system more efficiently.

Those ordinarily skilled in the art can appreciate that all or a part of the flow in the method of the foregoing embodiment may be performed by a computer program controlling relevant hardware, where the program may be stored in a computer readable storage medium, and the program may include the flow of the foregoing embodiment of the method upon being executed. Particularly the storage medium may be a magnetic disk, an optic disk, a Read Only Memory (ROM), a Random Access Memory (RAM), or any other form of storage medium.

The foregoing embodiments are merely representative of several embodiments of the disclosure by way of a detailed description thereof but shall not be construed hereby to limit the scope of the disclosure. It shall be noted that those ordinarily skilled in the art may further make several modifications and variations thereto without departing from the spirit of the disclosure, and these modifications and variations shall come into the scope of the disclosure. Accordingly the scope of the disclosure shall be as defined in the appended claims.

The foregoing detailed description has described only a few of the many possible implementations of the present disclosure. For this reason, this description of example embodiments is intended by way of illustration, and not by way of limitation. The methods, devices, and logic described above may be implemented in many different ways in many different combinations of hardware, software or both hardware and software.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

What is claimed is:

1. A test case screening method, comprising:
determining a number of times that a functional node has been triggered, wherein the functional node is one of a plurality of functional nodes of a software system;
calculating a weight for the functional node based on the number of times said functional node has been triggered; and
screening a set of test cases according to the weight of each respective functional node, to determine a subset of test cases pertinent to the plurality of functional nodes; and
testing said software system using the subset of test cases.

2. The test case screening method according to claim 1, wherein calculating the weight of the functional node further comprises:
calculating the weight of the functional node as a ratio of the number of times that the functional node has been triggered to a total number of times that all functional nodes among the plurality of functional nodes have been triggered.

3. The test case screening method according to claim 1, further comprising:
retrieving a number of times a user interface component associated with the functional node has been accessed; and
calculating the weight of the functional node based on the number of times the functional node has been triggered and the number of times the user interface component associated with the functional node has been accessed.

4. The test case screening method according to claim 3, wherein calculating the weight of the functional node further comprises:
calculating a first ratio of the number of times the functional node has been triggered to a total number of times that all functional nodes among the plurality of functional nodes have been triggered;
calculating a second ratio of the number of times that the user interface component associated with the functional node has been accessed to a total number of times all user interface components of the software system have been accessed; and
calculating the weight of the functional node as an average of the first ratio and the second ratio.

5. The test case screening method according to claim 1, wherein screening the set of test cases further comprises:
retrieving a preset number of functional nodes from the plurality of functional nodes that are ranked according to the weights, and selecting the subset of test cases pertinent to the retrieved functional nodes.

6. The test case screening method according to claim 1, wherein screening the set of test cases further comprises:
calculating an average weight of all functional nodes among the plurality of functional nodes;
retrieving functional nodes with corresponding weights above the average weight; and
selecting the subset of test cases pertinent to the retrieved functional nodes.

7. A test case screening system, comprising:
a trigger-times obtaining module adapted to obtain a number of times each functional node from a plurality of functional nodes of a software system has been triggered during operation of the software system;
a weight calculating module adapted to calculate a weight of each of the functional nodes based on the number of times that the each respective functional node has been triggered;
a test case screening module adapted to screen test cases pertinent to the functional nodes to select a subset of test cases according to the respective weights of the functional nodes; and
the test case screening system adapted to test the software system using the selected subset of test cases.

8. The test case screening system according to claim 7, wherein the weight calculating module is adapted to calculate the weight of a functional node as a ratio of the number of times that the functional node has been triggered to a total number of times that all the functional nodes have been triggered.

9. The test case screening system according to claim 7, wherein the trigger-times obtaining module is further adapted to retrieve a number of times a user interface component associated with the functional node has been accessed; and
the weight calculating module is adapted to calculate the weight of the functional node according to the number of times that the functional node has been triggered and the number of times that the user interface component associated with the functional node has been accessed.

10. The test case screening system according to claim 9, wherein
the weight calculating module is adapted to calculate a first ratio of the number of times that the functional node has been triggered to the total number of times all the functional nodes have been triggered;
the weight calculating module is further adapted to calculate a second ratio of the number of times that the user interface component associated with the functional node has been accessed to the total number of times all user interface components of the software system have been accessed; and
the weight calculating module is further adapted to calculate the weight of the functional node as an average of the first ratio and the second ratio.

11. The test case screening system according to claim 7, wherein,
the test case screening module is adapted to retrieve a first preset number of the functional nodes when the functional nodes are ranked according to the respective weights; and
the test case screening module is further adapted to select test cases pertinent to the retrieved functional nodes.

12. The test case screening system according to claim 7, wherein,
the test case screening module is adapted to calculate an average weight of all the functional nodes;
the test case screening module is further adapted to retrieve functional nodes with corresponding weights above the average weight; and
the test case screening module is further adapted to select test cases pertinent to the retrieved functional nodes.

13. A non-transitory computer storage medium comprising computer executable instructions adapted to perform a test case screening method, the non-transitory computer storage medium comprising:
instructions to retrieve a number of times a functional node has been triggered, the functional node is one of a plurality of functional nodes of a software system;
instructions to calculate a weight for the functional node based on the number of times the functional node has been triggered;
instructions to select test cases pertinent to the functional node according to the weight of the functional node; and
instructions to execute the selected test cases to test the software system.

14. The non-transitory computer medium of claim 13 further comprising:
instructions to calculate the weight for the functional node as a ratio of the number of times the functional node has been triggered to a total of the number of times each of the functional nodes has been triggered.

15. The non-transitory computer medium of claim 13 further comprising:
instructions to retrieve a number of times a user interface component associated with the functional node has been accessed; and
instructions to calculate the weight of the functional node according to the number of times the functional node has been triggered and the number of times the user interface component associated with the functional node has been accessed.

16. The non-transitory computer medium of claim 15, further comprising:
instructions to calculate a first ratio based on the number of times that the functional node has been triggered and a total of the number of times each of the functional nodes has been triggered;
instructions to calculate a second ratio based on the number of times that the user interface component associated with the functional node has been accessed and a total of the number of times each user interface component of the software system has been accessed; and
instructions to calculate the weight of the functional node as an average of the first ratio and the second ratio.

17. The non-transitory computer medium of claim 13, further comprising:
instructions to retrieve a first preset number of functional nodes when the functional nodes are ordered by corresponding weights; and
instructions to select test cases pertinent to the retrieved first preset number of functional nodes.

18. The non-transitory computer medium of claim 13, further comprising:
instructions to calculate an average weight of all the functional nodes;
instructions to retrieve functional nodes with corresponding weights greater than the average weight; and
instructions to select test cases pertinent to the retrieved functional nodes.
